(19) United States
(12) Patent Application Publication
(10) Pub. No.: US 2002/0071647 A1
(43) Pub. Date: Jun. 13, 2002

(54) Multi-clad optical fiber and amplifier

(76) Inventor: Tariq Manzur, Lincoln, RI (US)

Correspondence Address: BARLOW, JOSEPHS & HOLMES, LTD., 101 DYER STREET, 5TH FLOOR, PROVIDENCE, RI, 02903, US

(21) Appl. No.: 09/732,830

(22) Filed: Dec. 8, 2000

Related U.S. Application Data
(60) Provisional application No. 60/169,603, filed on Dec. 8, 1999.

(51) Int. Cl. G02B 6/22; G02B 6/16

(52) U.S. Cl. 385/127; 385/123; 359/341.1

(57) ABSTRACT

An optical amplifier (18) for proposed use in a free-space optical network includes a multi-clad optical fiber (10) having a single-mode core (12) doped with a rare-earth laser active dopant, a passive inner cladding (14) surrounding the core (12), and at least one outer cladding (16) surrounding the inner cladding (14). The amplifier (18) further includes a source of pump light (20) that is coupled directly into the core (12), and a source of signal light (22) that is coupled into the inner cladding (14). The signal light (30, 32) collected in the inner cladding (14) propagates along the optical fiber (10) for a distance sufficient for the signal light (32) to couple into the core (12) and for the signal light (32) to be amplified by the amplifying light (28) emitted within the core (12).

### BACKGROUND AND SUMMARY OF THE INVENTION

The instant invention relates to optical fibers and fiber optic amplifiers, and more particularly to a multi-clad optical fiber and fiber optic amplifier constructed with the multi-clad fiber.

Although optical fiber systems have seen tremendous growth and deployment over the past several years, the deployment of fiber systems in densely populated and developed metropolitan areas has run into difficulties in the physical deployment of fiber optic cables between buildings and along surface roads. As those skilled in the art are aware, each node in the network must be connected by optical fiber cables that must be physically laid out along or beneath surface roads or between interconnected buildings and switching stations.

Because of the difficulties in laying cable in some of these urban areas, fiber companies have developed an alternative wireless or cable-less system that is generally known in the industry as a free-space optical network. Much like microwave radios send RF signals through the air from transmitter to receiver, free-space optical equipment sends light from origination to destination without the use of fiber. While this free-space network solves the problem of physically laying fiber, it has its own attendant disadvantages. The first disadvantage is weather. Critical to the success of free-space optical networks is a direct, uninterrupted line of sight between transmitter and receiver. Rain, snow, smoke, atmospheric scintillation and building movement resulting from solar and wind loading can block, or attenuate, transmission between laser links. One of the biggest obstacles is fog, which is a serious attenuator of light at longer transmission distances. With system customers requiring 99.999% availability, even momentary lapses in signal transmission are unacceptable.

To overcome some of these problems, system vendors have developed deployment systems that limit link distance to only several hundred meters, and which provide redundant links to reroute traffic. Reducing the link distance significantly improves signal quality and strength but is a serious limitation to realistic deployment on a commercial basis. Longer link distances are obviously preferably and would provide more opportunities for commercial applications.

In this regard, the present invention seeks to provide a simple and efficient optical fiber and amplifier which can be used in a receiver station to amplifier the signal beam once received at the receiver station. Amplification of the signal beam will improve signal strength at the receiver before further transmission through the network and should permit longer link distances between transmitter and receiver, thus improving the overall viability of free-space optical networks.

More specifically, an optical amplifier for proposed use in a free-space optical network includes a multi-clad optical fiber having a single-mode core doped with a rare-earth laser active dopant, preferably erbium, in an amount sufficient to spontaneously emit amplifying light at a signal wavelength responsive to the application of a pumping light at a pumping wavelength. The optical fiber further includes a passive inner cladding surrounding the core, and at least one outer cladding surrounding the inner cladding. The disclosed embodiments comprise a double-clad fiber structure, although additional cladding layers are certainly possible and within the scope of the invention. The amplifier still further includes a source of pump light at a desired pumping wavelength that is coupled into the core and a source of signal light that is coupled into the inner cladding. Preferably, pump light is emitted by a pump laser diode, and focused directly into the core using optical lenses, although other means for introducing the pump light could be used to achieve the same effect. The signal light emitted by a remote transmitter station is collected in the inner cladding by optical lenses and propagates along the optical fiber for a distance sufficient for the signal light to couple into the core and for the signal light to be amplified by the amplifying light emitted within the core.

Accordingly, among the objects of the instant invention are: the provision of a multi-clad optical fiber having a single-mode core; the provision of such a fiber wherein the core is doped with a rare-earth laser active dopant in an amount sufficient to spontaneously emit amplifying light at a signal wavelength responsive to the application of a pumping light at a pumping wavelength; the provision of such an optical fiber wherein the inner cladding is passive, i.e. undoped; the provision of such a fiber that can be used as an amplifying medium for amplifying free-space optical signals; the provision of an optical fiber which is effective for use in a free-space optical receiver and amplifier; and the provision of a free-space optical receiver and amplifier including said optical fiber, a signal source, and a pump source.

Other objects, features and advantages of the invention shall become apparent as the description thereof proceeds when considered in connection with the accompanying illustrative drawings.

### BRIEF DESCRIPTION OF THE DRAWING FIGURES

In the drawings which illustrate the best mode presently contemplated for carrying out the present invention:

FIG. 1 is a cross-sectional view of a multi-clad fiber structure in accordance with the teachings of the present invention; and

FIG. 2 is a schematic cross-sectional view of a free-space optical receiver and amplifier showing a pump source, a signal source and a single-mode transmission fiber.

### DETAILED DESCRIPTION OF THE PREFERRED EMBODIMENT

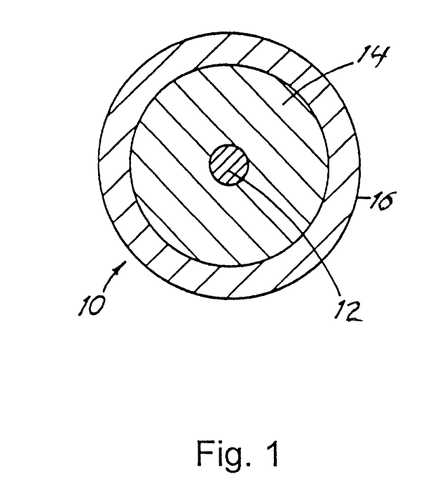

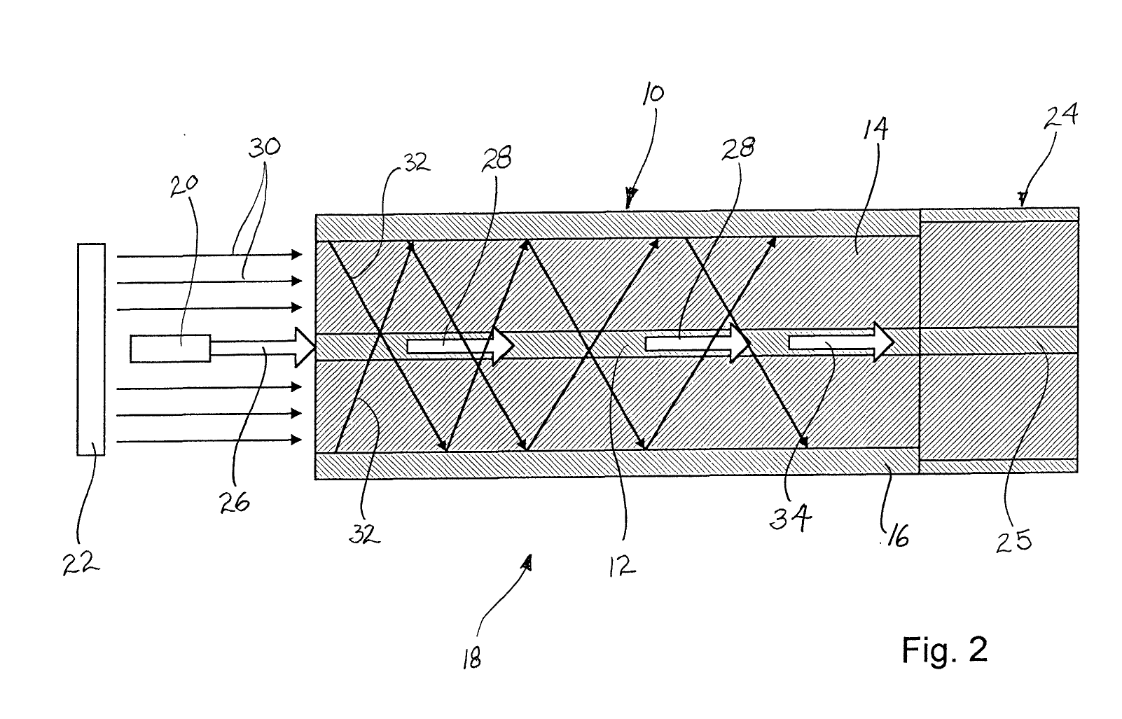

Referring now to the drawings, the optical fiber of the instant invention is illustrated and generally indicated at 10 in FIGS. 1 and 2.

The optical fiber 10 preferably comprises a multi-clad optical fiber including an active core 12, a passive inner cladding 12, and at least one outer cladding 14. The preferred embodiment as illustrated in the drawings comprises a dual-clad optical fiber, having an inner cladding and an outer cladding. However, it is to be understood that multiple cladding layers are possible and contemplated within the scope of the invention.

The core 12 preferably comprises a single-mode core that is doped with a rare-earth laser active dopant, preferably erbium, in an amount sufficient to spontaneously emit amplifying light at a signal wavelength responsive to the application of a pumping light at a pumping wavelength. In this regard, erbium is indicated as a preferred dopant material due to the prolific use of WDM transmission signals in the 1550 nm communication windows. It is also contemplated that other rare-earth laser active dopant materials, such as neodymium, praseodymium, and thulium will be equally applicable within the scope of the invention disclosed herein. The core 12 is indicated as preferably comprising a single-mode core which will allow only a single longitudinal mode to propagate through the core. This is advantageous in the present construction, as pump light will be introduced directly into the core 12. The fiber 10 could alternatively be constructed with a multi-mode core, although this is not preferred in the present embodiments.

The inner cladding 14 of the optical fiber 10 comprises a passive optical material. In other words, the inner cladding material does not contain any laser active dopant which will emit light responsive to pumping, although it may contain other non-active dopants, which are used to control other optical properties of the cladding. The inner cladding 14 provides a multi-mode signal path for the propagation of signal light along the length of the optical fiber 10. The details of this will be described further herein with regard to an optical amplifier construction.

The outer cladding is conventional in the art, and will not be described further herein.

Turning now to FIG. 2, an optical amplifier including the present optical fiber 10 is illustrated and generally indicated at 18. The optical amplifier 18 comprises an optical fiber 10, a source of pump light generally indicated at 20, a source of signal light generally indicated at 22, and a transmission fiber generally indicated at 24.

The optical fiber 10 is identical to the multi-clad construction as described hereinabove. The optical fiber 10 is provided in a length sufficient for amplifying the signal light propagated through the fiber. In this regard, the pump light and the signal light are coupled into a first end of the fiber 10 through the end surface thereof. The opposite, or second end of the fiber 10 is spliced or fused to the transmission fiber 24. The transmission fiber 24 comprises a single-mode fiber of conventional construction having a single-mode core 25 that is aligned with the core 12 of the optical amplifying fiber 10.

The source of pump light 20 can comprise any source that is capable of emitting a laser light beam 26 that can be directed. The pump light source 20 can include, but is not limited to, laser diodes, and laser diode bars that include an array of laser diodes. More preferably, the pump light source comprises a single mode diode pump laser operating in the 980/915/808 nm wavelength range. The pump light source 20 as defined within the scope of the present disclosure is to understood to include any appropriate or necessary optical elements, bulk optics, couplers, etc. (not shown) for focusing the pump light beam 26 into a confined area. The pump light source 20 is selected to emit light at a pumping wavelength suitable to pump the active dopant species as present in the core 12. The pump light beam 26 emitted by the pump light source 20 is coupled or focused directly into the core 12 where the pump light 26 is absorbed by the erbium ions, which in turn spontaneously emit amplifying light 28 at the desired signal wavelength.

The source of signal light 22 produces signal light beams 30 which are to be propagated through the inner cladding 14. Generally speaking, the signal source 22 can comprise any source of capable of emitting a modulated laser light beam 30 that can be directed to a defined area. The signal light source 22 can include, but is not limited to laser diodes as a source of light. The signal light source 22, as defined within the scope of the present disclosure is to understood to include any appropriate or necessary optical elements, bulk optic lenses, couplers, etc. (not shown) for focusing the signal light beams 30 into a confined area, i.e. the end surface of the fiber 10 as defined by the circumferential edge of the inner cladding 14.

In connection with the preferred embodiment, the light beams 30 of the signal source 22 preferably originate from a free-space optical network transmitter station. The signal beams travel through free-space and are received at a receiver station that can include bulk optics (not shown) for focusing the beams 30 into the end surface of the fiber 10. The light beams 30 that are collected into the inner cladding 14 propagate along the optical fiber for a distance sufficient for the signal light 32 to couple into the core 12 and for the signal light 34 in the core 12 to be amplified by the amplifying light 28 emitted within the core 12. In other words, as the signal propagates through the inner cladding 14, it crosses back and forth across the inner core 12 and is amplified by the pump light 28 travelling through the core 12. The amplified signal light 34 thereafter passes into the transmission fiber 24 for further transmission to other nodes of the network.

Because of the large surface area and Numerical Aperture of the inner cladding 14 of the fiber 10, beam coupling losses into the fiber 10 will be less. Furthermore, the noise of the amplifier 18 is low because it works as a normal rare-earth doped fiber amplifier.

It can therefore be seen that the instant invention provides a simple and efficient optical fiber 10 that can act a signal collecting structure and an amplifying medium for a signal collected in the inner cladding 14. The inner cladding 14 of the multi-clad fiber 10 provides a large surface area and large numerical aperture for collecting a signal to be amplified. Because of the large surface area and numerical aperture signal coupling losses are reduced. As the signal propagates through the fiber, it is eventually coupled into the core and is amplified along the longitudinal extent of the fiber by the pump beam launched into the core. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A multi-clad optical fiber comprising:
an active core including a rare-earth laser active dopant in an amount sufficient to spontaneously emit amplifying light at a signal wavelength responsive to the application of a pumping light at a pumping wavelength;
a passive inner cladding surrounding said core; and
at least one outer cladding surrounding said inner cladding.

2. The multi-clad optical fiber of claim 1 wherein said rare-earth laser active dopant is erbium.

3. The multi-clad optical fiber of claim 1 wherein said core and said inner cladding are circular and said core is concentrically located within said inner core.

4. The multi-clad optical fiber of claim 1 wherein said core is a single mode core.

5. The multi-clad optical fiber of claim 2 wherein said core is a single mode core.

6. The multi-clad optical fiber of claim 3 wherein said core is a single mode core.

7. An optical amplifier comprising:
a length of multi-clad optical fiber having a first end and a second end, said multi-clad optical fiber comprising
a single active core including a rare-earth laser active dopant in an amount sufficient to spontaneously emit amplifying light at a signal wavelength responsive to the application of a pumping light at a pumping wavelength,
a passive inner cladding surrounding said core, and
at least one outer cladding surrounding said inner cladding;
a source of pump light at said pumping wavelength, said pump light being coupled into said core at said first end of said length of multi-clad optical fiber; and
a source of signal light comprising light at said signal wavelength, said signal light being coupled into said inner cladding at said first end of said length of multi-clad optical fiber, wherein
said signal light propagates along the length of the multi-clad optical fiber for a distance sufficient for said signal light to couple into said core and for said signal light to be amplified by said amplifying light emitted within said core.

8. The optical amplifier of claim 7 wherein said rare-earth laser active dopant is erbium.

9. The optical amplifier of claim 7 wherein said core and said inner cladding are circular and said core is concentrically located within said inner core.

10. The optical amplifier of claim 7 wherein said core is a single mode core.

11. The optical fiber of claim 8 wherein said core is a single mode core.

12. The optical fiber of claim 9 wherein said core is a single mode core.

13. The optical amplifier of claim 7 further comprising a single-mode transmission fiber coupled to said second end of said multi-clad optical fiber.
